(19) United States
(12) Patent Application Publication
(10) Pub. No.: US 2025/0290300 A1
(43) Pub. Date: Sep. 18, 2025

(54) ALGINATE-BASED ATMOSPHERIC WATER HARVESTERS

(71) Applicant: Khalifa University of Science and Technology, Abu Dhabi (AE)

(72) Inventors: Samar Nasr ABD ELWADOOD, Abu Dhabi (AE); Georgios N. KARANIKOLOS, Patras (GR); Ludovic Francis DUMEE, Abu Dhabi (AE); Geert Jan WITKAMP, Thuwal (SA); Andreia Sofia Filipe FARINHA, Thuwal (SA)

(21) Appl. No.: 18/616,853

(22) Filed: Mar. 26, 2024

(30) Foreign Application Priority Data
Mar. 12, 2024 (GR) 20240100181

(51) Int. Cl. E03B 3/28; B01D 53/04; B01D 53/26; B01D 53/28; B01J 20/24; B01J 20/30

(52) U.S. Cl. CPC E03B 3/28; B01D 53/0407; B01D 53/261; B01D 53/28; B01J 20/24; B01J 20/3085; B01D 2253/202; B01D 2253/25; B01D 2257/80; B01D 2258/06; B01D 2259/40098

(57) ABSTRACT

An atmospheric water harvester may include a container, an evaporated water collection system at least partially within the container, and an alginate-based composite sorbent contained within the container. The alginate-based composite sorbent may be exposed to atmosphere in an uptake configuration and is exposed to the evaporated water collection system in an evaporation configuration.

### CROSS-REFERENCES TO RELATED APPLICATIONS

This application claims priority to Greek application Ser. No. 20240100181 filed Mar. 12, 2024, the entire content of which is hereby incorporated for all purposes in its entirety.

### BACKGROUND OF THE INVENTION

Water shortage is a pressing challenge in many arid areas, with an estimated 4 billion people living in water-stressed regions, including over 500 million severely impacted all year round. Although desalination and rainwater collection have been developed to address the problem of water scarcity, piping freshwater over long distances to landlocked regions remains extremely costly and unsustainable, leaving over 783 million people without access to safe drinking water. Solutions to produce locally freshwater, which do not rely on desalination must be developed to meet sustainably and effectively the demands arising from population growth and emerging industry's needs. Atmospheric water harvesting (AWH) is an innovative approach to overcoming water scarcity through decentralized water production.

Current AWH technologies include dew harvesting, rain collection, and fog capturing. However, each can be region-dependent and operate for a specific range of climatic and geographical conditions. Generating or collecting water from atmospheric moisture is a more eco-friendly and energy-efficient process compared to desalination of seawater because atmospheric moisture is primarily composed of fresh molecular water. However, due to the larger droplet sizes, salt may be present in fog and rainwater, but not to the extent salt is present in seawater. In many instances, salt separation will be needed, bringing associated cost and energy requirements. Therefore, an AWH technology that is region-independent and needs little to no salt separation would be valuable for addressing water shortage issues.

### BRIEF SUMMARY OF THE INVENTION

An atmospheric water harvester may comprise: a container; an evaporated water collection system at least partially within the container; and an alginate-based composite sorbent contained within the container, wherein the alginate-based composite sorbent is exposed to atmosphere in an uptake configuration and is exposed to the evaporated water collection system in an evaporation configuration.

A method may comprise: exposing an alginate-based composite sorbent to atmosphere; adsorbing atmospheric water with the alginate-based composite sorbent; evaporating at least a portion of the adsorbed water from the alginate-based composite sorbent; and collecting the evaporated water via condensation.

A method may comprise: mixing alginate, a hygroscopic additive, and a photothermal additive to form a mixture; and crosslinking the alginate in the mixture with a divalent cation and/or a trivalent cation to form an alginate-based composite sorbent.

### BRIEF DESCRIPTION OF THE DRAWINGS

FIG. 1 illustrates a flow diagram of a method for forming alginate-based composite sorbents according to at least some embodiments of the present disclosure.

FIG. 2 illustrates a flow diagram of a method according to at least some embodiments of the present disclosure.

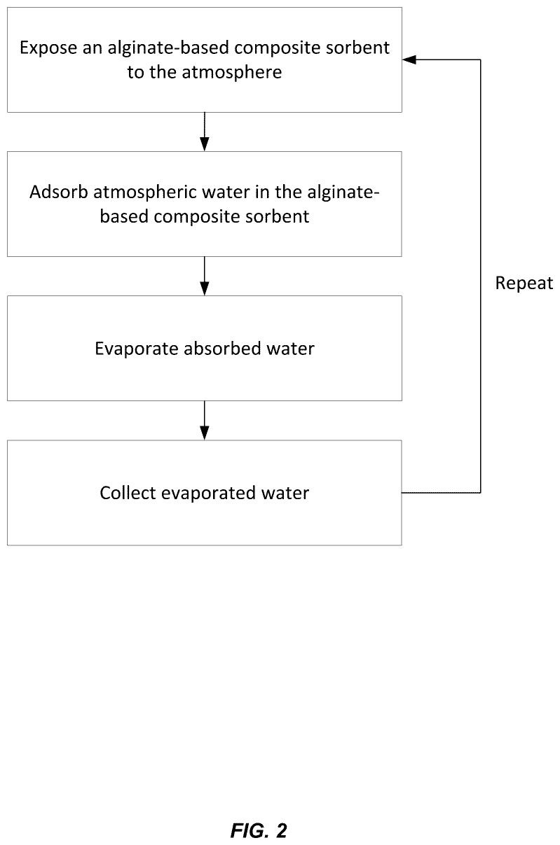

FIG. 3 is a photograph of an example of an atmospheric water harvester according to at least some embodiments of the present disclosure.

FIG. 4 illustrates a plot of the adsorption and desorption properties of alginate-based composite sorbents according to at least some embodiments of the present disclosure.

FIG. 5 illustrates a plot of a cycle of adsorption and desorption for an alginate-based composite sorbent according to at least some embodiments of the present disclosure.

FIG. 6 illustrates a plot of a cycle of adsorption and desorption for an alginate-based composite sorbent according to at least some embodiments of the present disclosure.

FIG. 7 illustrates a bar graph of the salt and total organic carbon in the condensed water collected from an alginate-based composite sorbent according to at least some embodiments of the present disclosure.

FIG. 8 illustrates a bar graph of the salt and total organic carbon in the condensed water collected from an alginate-based composite sorbent according to at least some embodiments of the present disclosure.

FIG. 9 illustrates a plot of the water uptake (grams of water per gram of sorbent) at different relative humidities for a variety of sorbents, including alginate-based composite sorbents, according to at least some embodiments of the present disclosure.

FIG. 10 illustrates a bar graph of the water uptake (grams of water per gram of sorbent) at 90% relative humidity and temperature of water desorption for a variety of sorbents including alginate-based composite sorbents according to at least some embodiments of the present disclosure.

### DETAILED DESCRIPTION OF THE INVENTION

The present disclosure relates to water harvesting and generation. More specifically, the water harvesters described herein comprise alginate-based composite sorbents capable of collecting water from the atmosphere and releasing said water for collection using evaporation. The alginate-based composite sorbents of the present disclosure generally include alginate for storing adsorbed water, a matrix material to provide structure and enhance hydrophilicity for water uptake, and photothermal particles that can be heated using sunlight to facilitate evaporation of the adsorbed water. These alginate-based composite sorbents offer several advantages, including high water uptake, low regeneration temperature, and fast kinetics, which make them highly efficient for AWH. Because of said advantages, the AWH of the present disclosure may operate using solar radiation without additional energy input.

Additionally, alginate is often used in the food industry as a thickener. Accordingly, the alginate-based composite sorbents described herein may have little to no adverse environmental impacts or health and safety implications.

Further, the starting materials for the alginate-based composite sorbents of the present disclosure are generally inexpensive and widely available, which allows for greater global use. Also, the formation of the alginate-based composite sorbents is a straightforward, scalable process, which further allows for greater global use.

### Alginate-Based Composite Sorbents

The present disclosure includes alginate-based composite sorbents that comprise crosslinked alginate, hygroscopic additives, and photothermal particles. Generally, the alginate-based composite sorbents have a porous structure and hydrophilic properties.

Alginates are linear polysaccharide polymers that contain two blocks: (i) M-block (mannuronic units) that contain a single carboxyl group and (ii) G-block (guluronic units) with two carboxyl groups. Alginates used in the methods and compositions of the present disclosure may be unfunctionalized alginates or functionalized alginates. For example, the alginate may be a methacrylated alginate, a polyethylene glycol-functionalize alginate, an unfunctionalized alginate, or a combination thereof.

Mixing soluble alginate with most trivalent or divalent cations produces cross-linked, insoluble hydrogel beads exhibiting stability and stiffness. Herein, the alginate may be crosslinked with divalent cations and/or trivalent cations. Examples may include, but are not limited to, calcium cations, magnesium cations, aluminum cations, iron cations, the like, or any combination thereof. Accordingly, salts thereof (e.g., chlorides, bromides, sulfates, nitrates, and the like) may be used to crosslink the alginate.

The crosslinked alginate may be present in an alginate-based composite sorbent at about 50 wt % to about 70 wt % (or about 50 wt % to about 60 wt %, or about 55 wt % to about 65 wt %, or about 60 wt % to about 70 wt %), based on the total weight of the alginate-based composite sorbent.

The hygroscopic additives may enhance the hydrophilicity of the alginate-based composite sorbent while also providing mechanical support that preserves the integrity of the porous network when cycling between adsorption and evaporation.

Examples of hygroscopic additives may include, but are not limited to, molecular sieves, activated alumina, hygroscopic salts, polypyrrole doped with chlorine (PPyCl), the like, and any combination thereof. Examples of molecular sieves may include but are not limited to, silicoaluminophosphate zeolites (e.g., silico-alumino-phosphate-34 zeolite (SAPO-34)), aluminosilicate zeolites, the like, and any combination thereof. Examples of hygroscopic salts may include, but are not limited to, lithium chloride, sodium chloride, calcium chloride, zinc chloride, calcium oxide, the like, and any combination thereof. In some instances, said salts may be useful both as hygroscopic additives and crosslinking agents for the alginate.

The hygroscopic additives may be present in an alginate-based composite sorbent at about 20 wt % to about 50 wt % (or about 20 wt % to about 30 wt %, or about 35 wt % to about 45 wt %, or about 30 wt % to about 50 wt %), based on the total weight of the alginate-based composite sorbent.

The photothermal particles may act as light absorbers that facilitate evaporation of the adsorbed water. Examples of photothermal particles may include, but are not limited to, graphene, carbon nanotubes, carbon black, activated carbon, an oxidized form of any of the forgoing (e.g., graphene oxide, oxidized carbon nanotubes, oxidized carbon black) the like, and any combination thereof.

The photothermal particles may be present in an alginate-based composite sorbent at about 1 wt % to about 5 wt % (or about 1 wt % to about 3 wt %, or about 2 wt % to about 4 wt %, or about 3 wt % to about 5 wt %), based on the total weight of the alginate-based composite sorbent.

### Forming Alginate-Based Composite Sorbents

The alginate-based composite sorbents of the present disclosure may generally be formed by crosslinking an alginate solution having hygroscopic additives and photothermal particles dispersed therein. The method may be carried out to produce an alginate-based composite sorbent of any desired size and shape. In some preferred embodiments, an alginate solution having hygroscopic additives and photothermal particles dispersed therein may be added as drops to a salt solution (e.g., calcium chloride or other crosslinking salt solution) to produce beads of alginate-based composite sorbents. Said beads may have a higher surface area than a pure alginate, allowing for a higher water adsorption and evaporation rate.

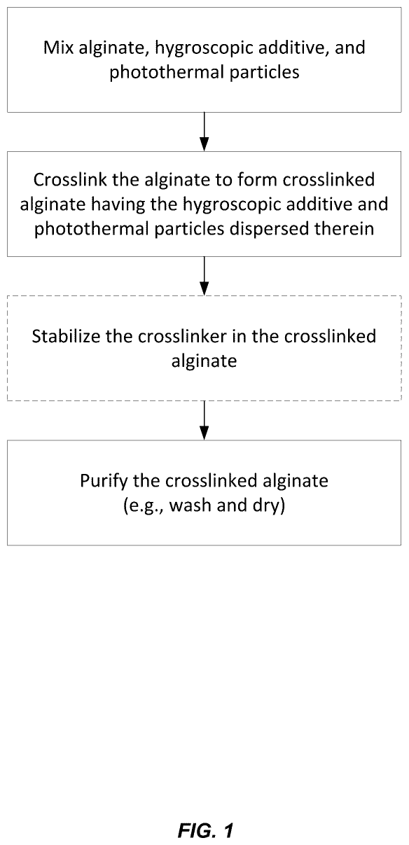

FIG. 1 illustrates a flow diagram of a method for forming alginate-based composite sorbents according to at least some embodiments of the present disclosure. The method includes mixing alginate, hygroscopic additives, and photothermal particles in water (or other suitable solvent or mixture of solvents). Generally, the alginate dissolves in the solvent, whereas the hygroscopic additives and the photothermal particles disperse in the solvent. The components may be added in any order. In a preferred embodiment, the hygroscopic additives and the photothermal particles disperse in the solvent, and then, the alginate is added. The dispersion can be mixed and/or heated when adding the alginate to promote dissolution and a homogeneous mixture.

The mixture of alginate, hygroscopic additives, and photothermal particles in the solvent is then crosslinked by contacting the mixture with a divalent cation salt (e.g., calcium chloride) and/or trivalent cation salt (aluminum chloride) solution. The salt solution can be added to the mixture, or the mixture can be added to the salt solution. For example, the mixture may be added drop wise to the salt solution to produce beads of the alginate-based composite sorbents. The beads may be of any size, for example, from about 1 mm in diameter to about 10 mm in diameter, or larger or smaller. In another example, a block or other structure may be formed.

Generally, the alginate-based composite sorbent has a porous structure because the crosslinking of alginate with salt cations forms a hydrogel with a controlled porous structure and high hygroscopicity.

Optionally, the alginate-based composite sorbent can be further treated to stabilize the crosslinker. For example, treating the alginate-based composite sorbent with a monovalent cation salt (e.g., lithium chloride) solution may mitigate the diffusion of the crosslinker and/or hygroscopic salts due to concentration gradients. The treating may include exposing the alginate-based composite sorbent to a stabilizer via soaking, washing, or the like. Advantageously, the cation of the monovalent cation salt does not replace the divalent and trivalent cations crosslinking the alginate.

Then, the alginate-based composite sorbent can be purified by washing with a solvent like ethanol and drying.

The alginate-based composite sorbent formed by said method and similar methods may then be used in AWH systems.

### Atmospheric Water Harvesters and Related Methods

Generally, methods for atmospheric water harvesting of the present disclosure include exposing the alginate-based composite sorbent to the atmosphere, adsorbing atmospheric water with the alginate-based composite sorbent, evaporating the adsorbed water, collecting the evaporated water, and repeating the foregoing steps for many cycles.

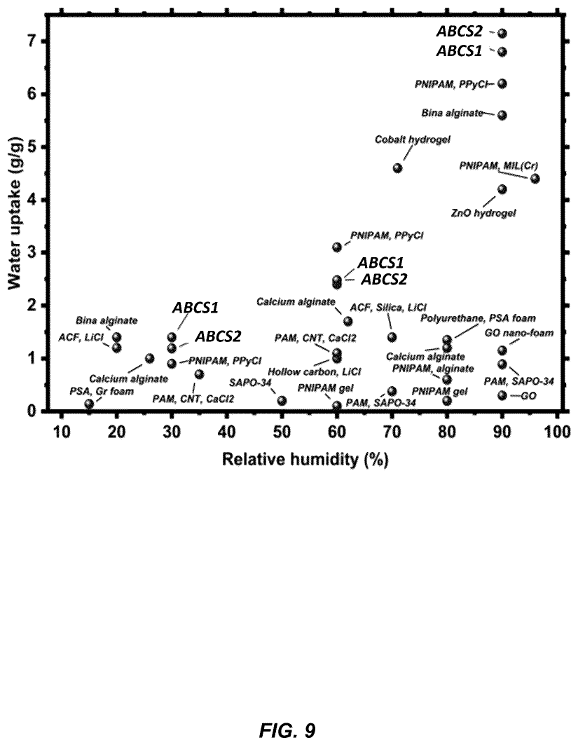

The hygroscopic and hydrophilic properties of the alginate-based composite sorbent allow it to absorb high concentrations of water. The amount of water adsorbed depends on the atmosphere's relative humidity. However, as illustrated in the examples, the alginate-based composite sorbent disclosed herein has comparable to superior water adsorption capacity compared to other existing technologies like cobalt hydrogels and zeolites across a wide range of relative humidities (see FIG. 9, which is described in more detail below). Advantageously, this property, and others, means the AWH with the alginate-based composite sorbent is not limited to a specific region or environmental conditions, thereby making it a global solution.

The alginate-based composite sorbent of the present disclosure may be capable of adsorbing at least 0.5 gram of atmospheric water per gram of the alginate-based composite sorbent (or about 0.5 g/g to about 1.5 g/g) at 30% relative humidity.

The alginate-based composite sorbent of the present disclosure may be capable of adsorbing at least 2 grams of atmospheric water per gram of the alginate-based composite sorbent (or about 2 g/g to about 3 g/g) at 60% relative humidity.

The alginate-based composite sorbent of the present disclosure may be capable of adsorbing at least 6.5 grams of atmospheric water per gram of the alginate-based composite sorbent (or about 6.5 g/g to about 7.5 g/g or more) at 90% relative humidity.

Once a desired amount of water is adsorbed (which does not have to be the maximum possible water adsorption) or a desired amount of time for adsorption has passed, the alginate-based composite sorbent can be heated to evaporate at least a portion (preferably at least 50%, more preferably at least 75%) of the adsorbed water. An advantage of the alginate-based composite sorbent disclosed herein is that the water desorption temperature is lower than other technologies, and the amount of heating is less. The lower desorption temperature makes the desorption process more efficient.

The photothermal particles in the alginate-based composite sorbent can convert sunlight into heat. Therefore, while an electric heater or other heating system may be used to heat the alginate-based composite sorbent, the alginate-based composite sorbent can be exposed to sunlight and heated sufficiently to cause evaporation of the adsorbed water. Accordingly, in some embodiments, the steps of adsorbing water, evaporating water, and collecting water may be performed without electricity or another power source.

The evaporated water is then collected, for example, by condensing the evaporated water on a surface and collecting the condensed water.

The condensed water (or the collected water) may contain about 0.02 mg/L or less (or 0 to about 0.02 mg/L, or about 0.001 mg/L to about 0.02 mg/L) of total organic carbon.

The condensed water (or the collected water) may cumulatively contain about 70 mg/L or less (e.g., about 50 mg/L or less, about 25 mg/L or less, or 0 to about 70 mg/L, or about 1 mg/L to about 70 mg/L) of calcium, lithium, sodium, magnesium, potassium, and aluminum. The condensed water (or the collected water) may contain about 60 mg/L or less (e.g., about 50 mg/L or less) of calcium. The condensed water (or the collected water) may contain about 0.2 mg/L or less (or about 0.1 mg/L or less) of lithium. The condensed water (or the collected water) may contain about 0.1 mg/L or less (e.g., about 0.05 mg/L or less) of sodium. The condensed water (or the collected water) may contain about 0.01 mg/L or less (e.g., about 0.005 mg/L or less) of magnesium. The condensed water (or the collected water) may contain about 3 mg/L or less (e.g., about 1 mg/L or less) of potassium. The condensed water (or the collected water) may contain about 0.01 mg/L or less (e.g., about 0.005 mg/L or less) of aluminum.

The water evaporation acts as a regeneration of the alginate-based composite sorbent so that it can be used again for water adsorption. The alginate-based composite sorbent of the present disclosure may be cycled through many water adsorption and water desorption cycles with minimal effect on the water adsorption capacity of the alginate-based composite sorbent. The number of water adsorption and water desorption cycles in methods of the present disclosure may be about 10 or more (or about 20 or more, or about 50 or more, or about 100 or more, or about 5 to about 100 or more, or about 5 to about 50, or about 20 to about 100 or more).

A variety of AWH configurations may be suitable for carrying out the methods of the present disclosure. Generally, an AWH will include (i) a container for containing the alginate-based composite sorbent while simultaneously exposing the alginate-based composite sorbent to the atmosphere and (ii) an evaporated water collection system.

The container and evaporated water collection system may be integral in a single apparatus. For example, a housing may include a first container, a port that allows the atmosphere to enter the housing and contact with the alginate-based composite sorbent in the first container (where the port closes during the evaporation step), a surface for condensing evaporated water, and a second container for collecting the condensed water where the surface and the second container are configured for the water to flow from the surface to the second container. Alternatively, the second container could be a second port where water flows from the surface to a tube, a trough, or other suitable structure that directs the condensed water to the second port for collection.

In another example, a conveyor may move container(s) of alginate-based composite sorbent along a path that exposes the alginate-based composite sorbent to the atmosphere and then exposes the alginate-based composite sorbent to heat (e.g., sunlight). The evaporated water from the heating process is collected. The conveyor may be in a continuous loop that allows for continuous or semi-continuous water production.

Many other configurations are contemplated.

### Nonlimiting Aspects of the Disclosure

Aspect 1. An atmospheric water harvester comprising: a container; an evaporated water collection system at least partially within the container; and an alginate-based composite sorbent contained within the container, wherein the alginate-based composite sorbent is exposed to atmosphere in an uptake configuration and is exposed to the evaporated water collection system in an evaporation configuration.

Aspect 2. The atmospheric water harvester of Aspect 1, wherein the alginate-based composite sorbent comprises: crosslinked alginate, a hygroscopic additive, and photothermal particles.

Aspect 3. The atmospheric water harvester of Aspect 2, wherein the crosslinked alginate is present at 50 wt % to 70 wt %, the hygroscopic additive is present at 20 wt % to 50 wt %, and the photothermal particles are present at 1 wt % to 5 wt %, each based on a total weight of the alginate-based composite sorbent.

Aspect 4. The atmospheric water harvester of Aspect 2 or 3, wherein the crosslinked alginate comprises: alginate crosslinked with a divalent cation and/or a trivalent cation.

Aspect 5. The atmospheric water harvester of any of Aspects 2-4, wherein the hygroscopic additive comprises one or more selected from the group consisting of: a molecular sieve, an activated alumina, a hygroscopic salt, polypyrrole doped with chlorine (PPyCl), and any combination thereof.

Aspect 6. The atmospheric water harvester of any of Aspects 2-5, wherein the photothermal particles comprise one or more selected from the group consisting of: graphene, carbon nanotubes, carbon black, activated carbon, an oxidized of any of the foregoing, and any combination thereof.

Aspect 7. The atmospheric water harvester of any of Aspects 1-6, wherein the alginate-based composite sorbent is capable of adsorbing at least 0.5 gram of atmospheric water per gram of the alginate-based composite sorbent at 30% relative humidity, adsorbing at least 2 grams of atmospheric water per gram of the alginate-based composite sorbent at 60% relative humidity, and adsorbing at least 6.5 grams of atmospheric water per gram of the alginate-based composite sorbent at 90% relative humidity.

Aspect 8. The atmospheric water harvester of any of Aspects 1-7, wherein the evaporated water collection system comprises: a condensation surface and a condensed water collector configured to collect condensed water from the condensation surface.

Aspect 9. A method comprising: exposing an alginate-based composite sorbent to atmosphere; adsorbing atmospheric water with the alginate-based composite sorbent; evaporating at least a portion of the adsorbed water from the alginate-based composite sorbent; and collecting the evaporated water via condensation.

Aspect 10. The method of Aspect 9 further comprising: repeating the exposing, the adsorbing, the evaporating, and the collecting steps at least 10 times.

Aspect 11. The method of any of Aspects 9-10, wherein the evaporating step comprises: exposing the alginate-based composite sorbent to sunlight.

Aspect 12. The method of any of Aspects 9-11, wherein the exposing, the adsorbing, the evaporating, and the collecting steps do not use electricity.

Aspect 13. The method of any of Aspects 9-12, wherein the alginate-based composite sorbent adsorbs at least 0.5 gram of atmospheric water per gram of the alginate-based composite sorbent at 30% or greater relative humidity before the collecting step.

Aspect 14. The method of any of Aspects 9-13, wherein the alginate-based composite sorbent adsorbs at least 2 grams of atmospheric water per gram of the alginate-based composite sorbent at 60% or greater relative humidity before the collecting step.

Aspect 15. The method of any of Aspects 9-14, wherein the alginate-based composite sorbent adsorbs at least 6.5 grams of atmospheric water per gram of the alginate-based composite sorbent at 90% or greater relative humidity before the collecting step.

Aspect 16. The method of any of Aspects 9-15, wherein the alginate-based composite sorbent comprises: crosslinked alginate, a hygroscopic additive, and photothermal particles.

Aspect 17. The method of any of Aspects 9-16, wherein the condensed water contains 0.02 mg/L or less of total organic carbon.

Aspect 18. The method of any of Aspects 9-17, wherein the condensed water contains 70 mg/L or less of calcium, lithium, sodium, magnesium, potassium, and aluminum, cumulatively.

Aspect 19. A method comprising: mixing alginate, a hygroscopic additive, and a photothermal additive to form a mixture; and crosslinking the alginate in the mixture with a divalent cation and/or a trivalent cation to form an alginate-based composite sorbent.

Aspect 20. The method of Aspect 19, wherein the alginate-based composite sorbent is capable of adsorbing at least 0.5 gram of atmospheric water per gram of the alginate-based composite sorbent at 30% relative humidity, adsorbing at least 2 grams of atmospheric water per gram of the alginate-based composite sorbent at 60% relative humidity, and adsorbing at least 6.5 grams of atmospheric water per gram of the alginate-based composite sorbent at 90% relative humidity.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art. Indeed, the methods and systems described herein may be embodied in a variety of other forms; furthermore, various omissions, substitutions, and changes in the form of the methods and systems described herein may be made without departing from the spirit of the present disclosure. The accompanying claims and their equivalents are intended to cover such forms or modifications as would fall within the scope and spirit of the present disclosure.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and all three of A and B and C.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

### EXAMPLES

### Example 1. Preparation of Alginate-Based Composite Sorbent 1 (ABCS1)

SAPO-34 powder (hygroscopic additive) and graphene oxide (GO) (photothermal particles) were suspended in water. Then, sodium alginate was slowly introduced to the suspension at 80° C. while stirring. Once alginate was dissolved in the water, the as-prepared solution was added dropwise into a saturated calcium chloride solution. After about 12 hours, the calcium alginate particles (or beads of crosslinked alginate having SAPO-34 and GO dispersed therein) were filtered, and the resulting beads were soaked in a lithium chloride-saturated solution. Although lithium cannot be replaced with calcium, the lithium chloride solution was used in a very small amount to prevent the diffusion of stored calcium chloride in the beads due to the concentration gradient of particles and external solution. After about 24 hours, the beads were separated, washed several times with ethanol, and dried overnight. Without being limited by theory, it is believed that in this process, calcium replaces sodium from the G-blocks, and then sodium is replaced by lithium in the M-blocks.

### Example 2. Preparation of Alginate-Based Composite Sorbent 2 (ABCS2)

Polypyrrole doped with chlorine (PPyCl) powder (hygroscopic additive), and GO were first suspended in water. Then, sodium alginate was slowly added to the suspension at 80° C. while stirring. Once alginate was dissolved in the water, the as-prepared solution was then added dropwise into a saturated calcium chloride solution, forming calcium alginate particles (or beads of crosslinked alginate having PPyCl and GO dispersed therein). After about 12 hours, the formed beads were filtered and soaked in a lithium chloride-saturated solution. After about 24 hours, the formed beads were separated, washed several times with ethanol, and dried overnight.

### Example 3. Performance of ABCS1 and ABCS2 in AWH

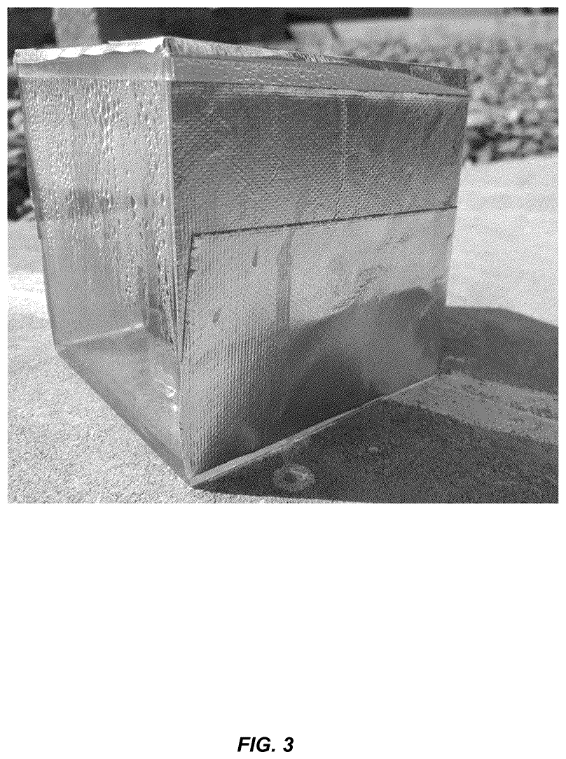

An AWH (see FIG. 3) was built with a transparent plastic cube, light-insulation sheets on at least three of the walls of the cube, a petri dish with ABCS1 or ABCS2 therein, and an evaporated water collection system (e.g., an angled surface above the petri dish that allows for water that condenses thereon to flow into a collection container like another petri dish).

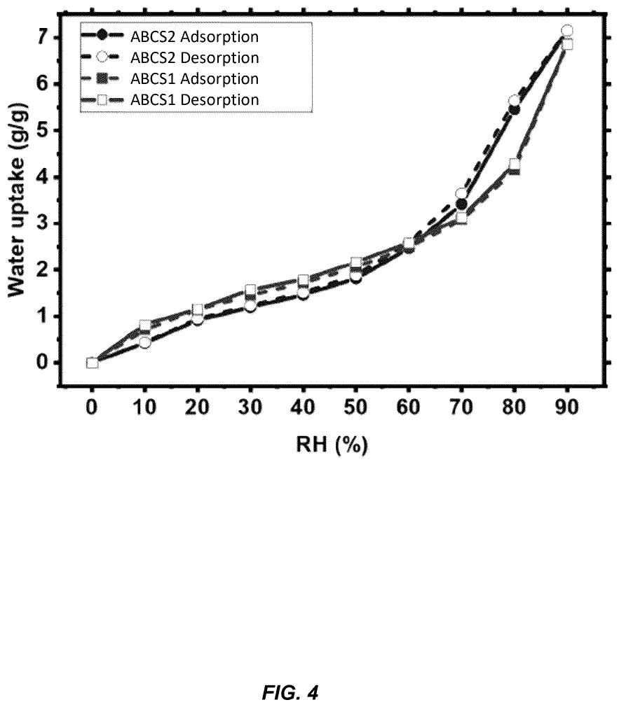

FIG. 4 illustrates a plot of the water uptake (grams of water per grams of ABCS) (or water content in the ABCS) as a function of relative humidity for an adsorption/desorption cycle for each of ABCS1 and ABCS2. In both, the water content was consistent for both the adsorption and desorption steps at each relative humidity. This illustrates the rate of adsorption and desorption is high, and equilibrium is reached relatively quickly.

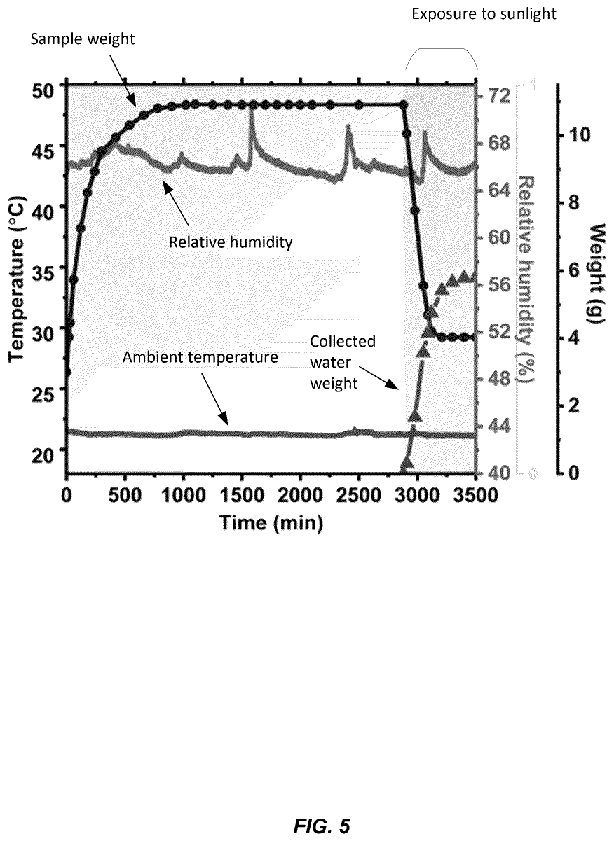

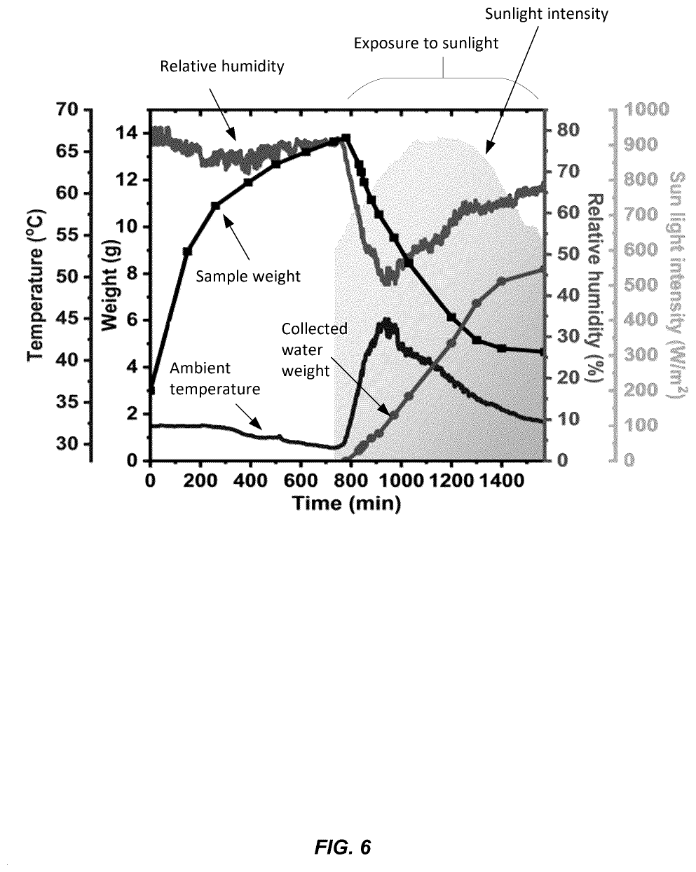

FIGS. 5-6 illustrate plots of multiple variables as a function of time for an adsorption/desorption cycle for the ABCS1 in an indoor placement and an outdoor placement. Because the indoor temperature is controlled, exposure to the sun did not increase the temperature, but water still evaporated in the AWH. With an outdoor placement, the increased temperature during sun exposure increased the amount of water evaporated and collected.

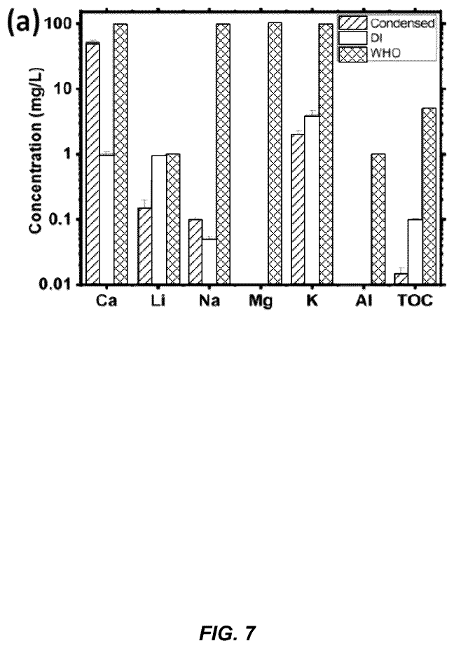

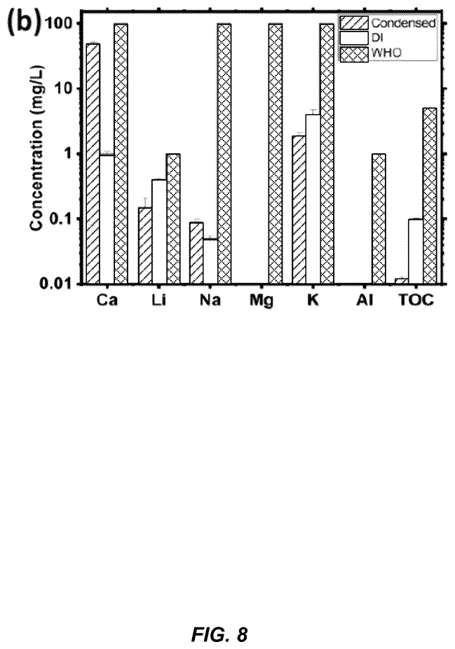

FIGS. 7-8 illustrates a bar graph of the concentration of calcium, lithium, sodium, magnesium, potassium, and aluminum and the total organic carbon (TOC) (determined by inductively coupled plasma-optical emission spectroscopy (ICP-OES) and TOC analyses) for the condensate produced in a AWH using ABCS1 (FIG. 7) and ABCS2 (FIG. 8) compared to the same for deionized water and the World Health Organization (WHO) water purification standards.

FIG. 9 illustrates a plot of the water uptake (grams of water per gram of sorbent) at different relative humidities for a variety of sorbents, including ABCS1 and ABCS2. The sorbents of the present disclosure have comparable water uptake capacity at lower humidities (e.g., 30% relative humidity) compared to other sorbates, improved water uptake capacity at moderate humidities (e.g., 60% relative humidity) compared to other sorbates, and superior water uptake capacity at high humidities (e.g., 90% relative humidity) compared to other sorbates.

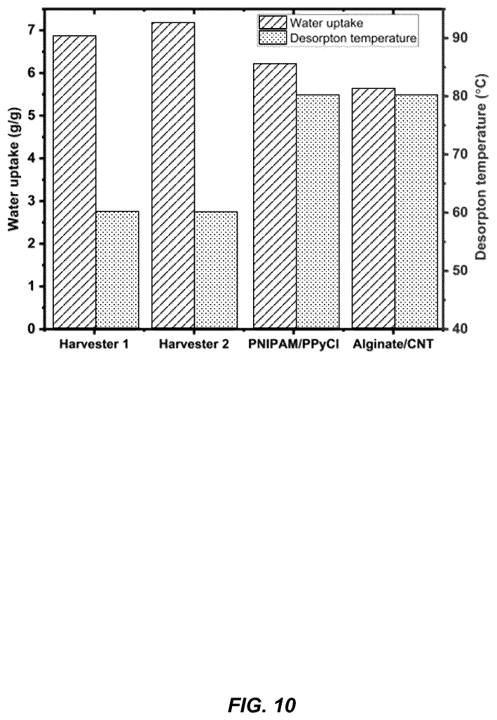

FIG. 10 illustrates a bar graph of the water uptake (grams of water per grams of sorbent) at 90% relative humidity and temperature of water desorption for ABCS1, ABCS2, PPyCl-doped pol (N-isopropylacrylamide) (PNIPAm/PPyCl), and carbon nanotube-doped alginate. The sorbents of the present disclosure have a higher water uptake capacity and a lower desorption temperature.

When cycled through 10 adsorption/desorption cycles, the ABCS1 and ABCS2 had about 100 wt % water uptake and a water releasing efficiency of about 88 wt % using solar radiation.

The various features and processes described above may be used independently of one another or may be combined in various ways. All possible combinations and sub-combinations are intended to fall within the scope of the present disclosure. In addition, certain methods or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

All references, including publications, patent applications, and patents, cited herein are hereby incorporated by reference to the same extent as if each reference were individually and specifically indicated to be incorporated by reference and were set forth in its entirety herein.

What is claimed is:

1. An atmospheric water harvester comprising:
a container;
an evaporated water collection system at least partially within the container; and
an alginate-based composite sorbent contained within the container, wherein the alginate-based composite sorbent is exposed to atmosphere in an uptake configuration and is exposed to the evaporated water collection system in an evaporation configuration.

2. The atmospheric water harvester of claim 1, wherein the alginate-based composite sorbent comprises: crosslinked alginate, a hygroscopic additive, and photothermal particles.

3. The atmospheric water harvester of claim 2, wherein the crosslinked alginate is present at 50 wt % to 70 wt %, the hygroscopic additive is present at 20 wt % to 50 wt %, and the photothermal particles are present at 1 wt % to 5 wt %, each based on a total weight of the alginate-based composite sorbent.

4. The atmospheric water harvester of claim 2, wherein the crosslinked alginate comprises: alginate crosslinked with a divalent cation and/or a trivalent cation.

5. The atmospheric water harvester of claim 2, wherein the hygroscopic additive comprises one or more selected from the group consisting of: a molecular sieve, an activated alumina, a hygroscopic salt, polypyrrole doped with chlorine (PPyCl), and any combination thereof.

6. The atmospheric water harvester of claim 2, wherein the photothermal particles comprise one or more selected from the group consisting of: graphene, carbon nanotubes, carbon black, activated carbon, an oxidized of any of the foregoing, and any combination thereof.

7. The atmospheric water harvester of claim 1, wherein the alginate-based composite sorbent is capable of adsorbing at least 0.5 gram of atmospheric water per gram of the alginate-based composite sorbent at 30% relative humidity, adsorbing at least 2 grams of atmospheric water per gram of the alginate-based composite sorbent at 60% relative humidity, and adsorbing at least 6.5 grams of atmospheric water per gram of the alginate-based composite sorbent at 90% relative humidity.

8. The atmospheric water harvester of claim 1, wherein the evaporated water collection system comprises: a condensation surface and a condensed water collector configured to collect condensed water from the condensation surface.

9. A method comprising:
exposing an alginate-based composite sorbent to atmosphere;
adsorbing atmospheric water with the alginate-based composite sorbent;
evaporating at least a portion of the adsorbed water from the alginate-based composite sorbent; and
collecting the evaporated water via condensation.

10. The method of claim 9 further comprising:
repeating the exposing, the adsorbing, the evaporating, and the collecting steps at least 10 times.

11. The method of claim 9, wherein the evaporating step comprises: exposing the alginate-based composite sorbent to sunlight.

12. The method of claim 9, wherein the exposing, the adsorbing, the evaporating, and the collecting steps do not use electricity.

13. The method of claim 9, wherein the alginate-based composite sorbent adsorbs at least 0.5 gram of atmospheric water per gram of the alginate-based composite sorbent at 30% or greater relative humidity before the collecting step.

14. The method of claim 9, wherein the alginate-based composite sorbent adsorbs at least 2 grams of atmospheric water per gram of the alginate-based composite sorbent at 60% or greater relative humidity before the collecting step.

15. The method of claim 9, wherein the alginate-based composite sorbent adsorbs at least 6.5 grams of atmospheric water per gram of the alginate-based composite sorbent at 90% or greater relative humidity before the collecting step.

16. The method of claim 9, wherein the alginate-based composite sorbent comprises: crosslinked alginate, a hygroscopic additive, and photothermal particles.

17. The method of claim 9, wherein the condensed water contains 0.02 mg/L or less of total organic carbon.

18. The method of claim 9, wherein the condensed water contains 70 mg/L or less of calcium, lithium, sodium, magnesium, potassium, and aluminum, cumulatively.

19. A method comprising:
mixing alginate, a hygroscopic additive, and a photothermal additive to form a mixture; and
crosslinking the alginate in the mixture with a divalent cation and/or a trivalent cation to form an alginate-based composite sorbent.

20. The method of claim 19, wherein the alginate-based composite sorbent is capable of adsorbing at least 0.5 gram of atmospheric water per gram of the alginate-based composite sorbent at 30% relative humidity, adsorbing at least 2 grams of atmospheric water per gram of the alginate-based composite sorbent at 60% relative humidity, and adsorbing at least 6.5 grams of atmospheric water per gram of the alginate-based composite sorbent at 90% relative humidity.
